(19) United States
(12) Patent Application Publication
(10) Pub. No.: US 2017/0032334 A1
(43) Pub. Date: Feb. 2, 2017

(54) METHOD AND SYSTEM FOR MANAGING SERVICE WORK FLOW

(71) Applicant: Michael Martinez, Las Vegas, NV (US)

(72) Inventor: Michael Martinez, Las Vegas, NV (US)

(21) Appl. No.: 15/211,931

(22) Filed: Jul. 15, 2016

Related U.S. Application Data
(60) Provisional application No. 62/192,928, filed on Jul. 15, 2015.

(51) Int. Cl. G06Q 10/00; G06Q 50/16; G06Q 10/06

(52) U.S. Cl. CPC G06Q 10/20; G06Q 10/06313; G06Q 10/06315; G06Q 50/163

(57) ABSTRACT

A method and system for managing services are provided. The services management system includes a main database manager that is communicatively coupled to a plurality of entities in said services management system. The services management system also includes an inventory component configured to receive hardware usage data from said main database manager. The services management system includes a proposal generator configured to receive manual inputs from a user at a work site, said manual inputs comprising at least one of a photo of a scope of work and a graphic icon representing a task, determine information required to generate a proposal, transmit a request to said main database manager for the determined information, receive the requested information, and generate said proposal based on the manual inputs and the received information. The services management system also includes a communication component configured to transmit and track a status of said generated proposal.

### CROSS REFERENCE TO RELATED APPLICATIONS

This application claims priority to and the benefit of the filing date of U.S. Provisional Application No. 62/192,928 filed on Jul. 15, 2015, which is hereby incorporated by reference in its entirety.

### BACKGROUND

This description relates to managing services provided to an owner or administrator of a property, and, more particularly, to a network-based method and system for generating, previewing, approving and documenting a determined scope of work and inventory or parts and tools needed to perform the scope of work.

Many service providers, especially those that manage relatively lower skill workers and workers with a diversity of language proficiencies have different functions within the organization that need to communicate with each other remotely. For example, a foreman at a job site may observe an item that should be addressed, but that is outside a predefined work scope of that foreman. Heretofore, the foreman may or may not identify the observed item and if he did, he would most likely informally mention the observed item to a supervisor, who may or may not document the observed item. However, documenting the observed item, preparing a proposal for the property owner or manager could facilitate the amount of work the service provider could be doing for the property owner. Not documenting the observed item and following through with proposal to remedy the problem with the observed item is a lost opportunity for the service provider.

Additionally, while performing a predefined scope of work for a property owner or manager, parts, tools, and consumables may be used, which if not documented properly may be challenged by the property owner as actually having been used. Moreover, when used, the parts, tools, and consumables are unavailable for other jobs until they are replenished. Identifying the parts, tools, and consumables with a degree of specificity to a central ordering location permits the timely replenishment of the parts, tools, and consumables while potentially taking advantage of bulk buying or volume discounts, further providing profit opportunities to the service provider.

### BRIEF DESCRIPTION

In one embodiment, a services management system includes a main database manager comprising a main database and a processor communicatively coupled to the main database. The main database manager is communicatively coupled to a plurality of entities in said services management system. The services management system also includes an inventory component managed by a vendor entity of the plurality of entities, said inventory component configured to receive hardware usage data from said main database manager. The services management system further includes a proposal generator configured to receive manual inputs from a user at a work site, said manual inputs comprising at least one of a photo of a scope of work and a graphic icon representing a task, determine information required to generate a proposal, transmit a request to said main database manager for the determined information, receive the requested information, and generate said proposal based on the manual inputs and the received information. The services management system also includes a communication component configured to transmit and track a status of said generated proposal.

In another embodiment, one or more non-transitory computer-readable storage media has computer-executable instructions embodied thereon, wherein when executed by at least one processor, the computer-executable instructions cause the processor to receive a specified scope of work from the computer device located at a site of a performance of the work, generate a draft proposal for performing the scope of work at the site of the performance of the work, and transmit an approval request, including the draft proposal, to a site remote from the site of the performance of the work. The computer-executable instructions also cause the processor to receive, from the remote site, at least one of an approval the draft proposal of the scope of work and denial of the draft proposal of the scope of work, transmit the approved proposal to a client associated with the identified location of the specified scope of work, and receive from the client an approval to perform the specified scope of work.

In yet another embodiment, a computer-implemented method implemented using a computer device coupled to a user interface and a memory device includes receiving specified scope of work from the computer device located at a site of a performance of the work, generating, on the computer device, a draft proposal for performing the scope of work at the site of the performance of the work, transmitting an approval request, including the draft proposal, to a site remote from the site of the performance of the work, receiving, from the remote site, at least one of an approval the draft proposal of the scope of work and denial of the draft proposal of the scope of work, transmitting the approved proposal to a client associated with the identified location of the specified scope of work, and receiving from the client an approval to perform the specified scope of work.

### BRIEF DESCRIPTION OF THE DRAWINGS

FIGS. 1-21 show example embodiments of the methods and systems described herein.

FIG. 1 is a block diagram of a services management system in accordance with an example embodiment of the present disclosure.

FIG. 2 is a simplified block diagram of the services management system shown in FIG. 1.

FIG. 3 is an expanded block diagram of the services management system shown in FIG. 2 in accordance with one example embodiment of the present disclosure.

FIG. 4 illustrates an example configuration of a user system operable by the field entity shown in FIG. 1.

FIG. 5 illustrates an example configuration of the server system shown in FIGS. 2 and 3.

FIG. 6 is a block diagram of the computing devices shown in FIGS. 4 and 5.

FIG. 7 is a screen capture of a welcome display of the user computing device of services management system shown in FIG. 1.

FIG. 8 is a screen capture of a camera viewfinder display of the user computing device shown in FIGS. 4 and 5 in accordance with an example embodiment of the present disclosure.

FIG. 9 is a screen capture of a proposal list selection menu display that includes a proposal selection menu.

FIG. 10 is a screen capture of a maintenance list display screen.

FIG. 11 is another screen capture of maintenance list display screen.

FIG. 12 is another screen capture of maintenance list display screen indicating a list of maintenance activities to be performed.

FIG. 13 is a screen capture of an admin site page of the services management system shown in FIG. 1.

FIG. 14 is a screen capture of an admin site proposal detail page of the services management system shown in FIG. 1.

FIG. 15 is a screen capture of an admin site maintenance details page of the services management system shown in FIG. 1.

FIG. 16 is a screen capture of an admin site irrigation parts and service detail page of the services management system shown in FIG. 1.

FIG. 17 is a screen capture of an admin site add client map page.

FIG. 18 is a screen capture of a maintenance task entry page of the services management system shown in FIG. 1.

FIG. 19 is a screen capture of an admin site damage repair task entry page.

FIG. 20 is a data flow diagram of the services management system shown in FIG. 1.

FIG. 21 is a flow chart of a computer-implemented method for managing services using a computer device coupled to a user interface and a memory device.

### DETAILED DESCRIPTION

The following detailed description illustrates embodiments of the disclosure by way of example and not by way of limitation. It is contemplated that the disclosure has general application to analytical and methodical embodiments of managing a work flow and inventory control of a service provider organization in industrial, commercial, and residential applications.

Embodiments of the present disclosure describe a back end portal that captures client data for front end delivery. The work flow and inventory control management system is configured to utilize back end data input to recognize and locate items on a property location defined in the back end for use on wireless devices. The work flow and inventory control management system is configured to acquire photos and GPS locations of work scopes on client owned or managed property and to locate client owned assets needing repair/replacement or service as a component to a proposal. The work flow and inventory control management system is further configured to consolidate the acquired photos and GPS locations into a proposal document, document selected items and configuring quantities and pricing of identified items and calculating a proposed value for delivery to a client into a single outputted report in the form of, for example, an email. In other embodiments, the outputted report is provided in other message forms.

The work flow and inventory control management system is also configured to generate the email with the system captured photos and links to GPS location of proposed items formatted into the body of the email. The work flow and inventory control management system is configured to receive from the client a response indicating an acceptance, a decline, or a tabling of the proposal via respective one click buttons that automatically send a proposal status reply back to the service provider and back end components for user proposal processing. The back-end system of the work flow and inventory control management system captures and archives all proposal data from date captured thru proposal acceptance and provides metric and performance reporting on quantity/originator/proposals generated revenue/revenue per proposal and foreman/approved versus confirmed and any combination of select metrics.

The following description refers to the accompanying drawings, in which, in the absence of a contrary representation, the same numbers in different drawings represent similar elements.

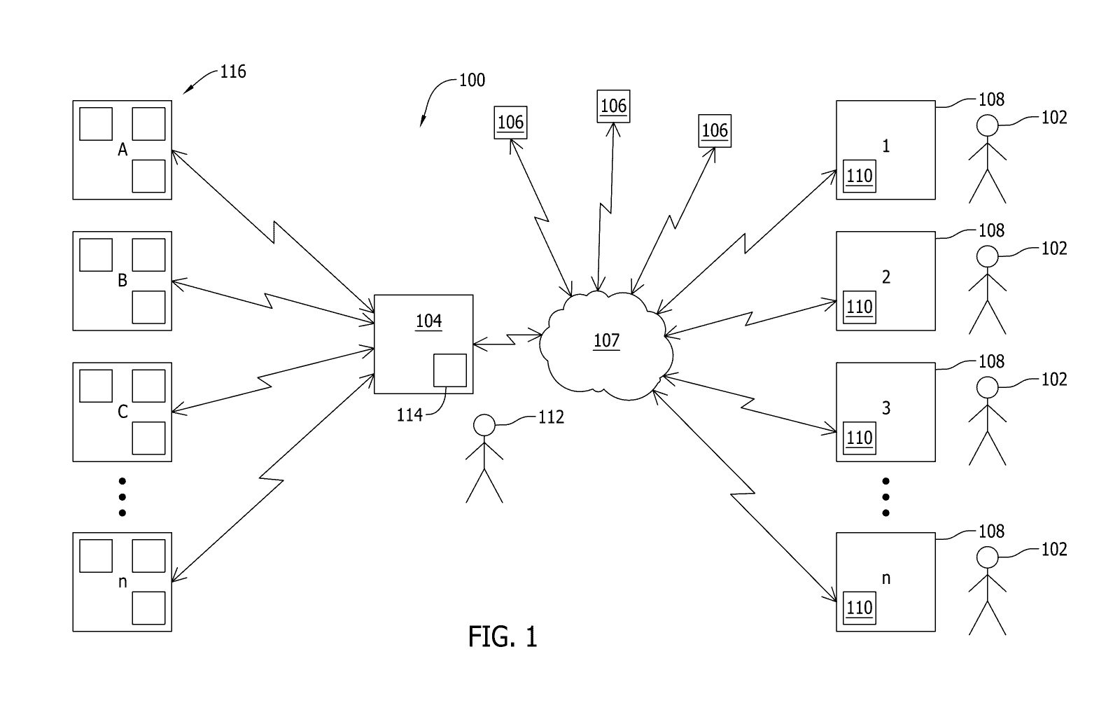

FIG. 1 is a block diagram of a services management system 100 configured to manage interactions between field entities 102, such as job foremen, a services entity server system 104, in the example embodiment, a landscaping services provider 105, and clients 106 of services entity server system 104. In the example embodiment, field entities 102, services entity server system 104, and clients 106 communicate using a network 107, which may include a proprietary network or public network, such as the Internet. Field entities 102 each use a user computing device 108 to enter services data into a predefined proposal generator 110 configured to receive the services data and prompt field entity 102 for additional data in a guided format using predefined iconic inputs and captured visual data, such as photos of potential work sites. In the example embodiment, proposal generator 110 is illustrated as being a part of user computing device 108, it should be observed that proposal generator 110 may also form a part of services entity server system 104.

A mobile based app 111 executing on user computing device 108 uses file compression technology to provide field entity 102 with a visual library 113 including a plurality of proposal inventory icons to select from. Mobile based app 111 combines the library selection with GPS technology to use a marker and define a location of the selected item on a map associated with the GPS technology. Mobile based app 111 then automatically accesses a camera function 115 without having to exit the active process to seamlessly allow field entity 102 to photograph the specific issue or repair needed. Mobile based app 111 then seamlessly integrates the photo taken into the GPS map proximate the map marker. Using touch technology, GPS, a photo functionality, and proposal descriptions and pricing from a back-end system 117 including a pricing database 121, mobile based app 111 consolidates all the functionality that are specifically tied to each inventory item tied to from the estimate without having to exit mobile based app 111. Back-end system 117 may be owned and/or operated by a third party, such as, but not limited to, a vendor. In other embodiments, back-end system 117 may be owned and/or operated in-house.

When field entity 102 has entered sufficient data to generate proposal 109, proposal generator 110 transmits proposal 109 via electronic message, such as, an email message, to a supervisor 112 at services entity server system 104. In the example embodiment, supervisor 112 is illustrated as being a human supervisor of field entity 102. However, in various embodiments, supervisor 112 is embodied in a supervisory module 119 configured to receive proposal 109, verify proposal 109 meets predefined accuracy and formatting specifications, and if so supervisor 112 or supervisory module 119 transmits proposal 109 to a respective client 106. In other embodiments, supervisory module 119 receives proposal 109, verifies proposal 109 meets predefined accuracy and formatting specifications, and if so transmits proposal 109 to supervisor 112.

Client 106 receives proposal 109 and may approve proposal 109 as is and in total, may approve only portions of proposal 109, may alter and approve proposal 109, or may indicate an acknowledgement of receipt of proposal 109, but not an approval of proposal 109, thereby services entity server system 104 may regularly remind client 106 of the pending proposal 109 or portion of a proposal work scope that still needs approval.

Moreover, field entity 102 may use user computing device 108 to document predefined maintenance activities that may be performed on a periodic basis. For example, recurring periodic maintenance may be arranged to be performed at a predefined time interval or other interval, such as, an interval related to a growing rate of plants, which may require different time periods at different times of the year.

A plurality of back-end systems 117 including back-end systems 117 may be utilized to support services entity server system 104 and field entity 102 in preparing proposal 109 and in documenting the maintenance activities. Moreover, some back-end systems 117 receive data from services entity server system 104 and generate business data, which back-end systems 117 then transmit back to services entity server system 104 for approval and/or other action.

Mobile based app 111 accesses thousands of images from an inventory library 116 in back-end systems 117 and makes them accessible to the front end of app 111. Mobile based app 111 also pulls specific predetermined description and pricing data associated with those inventory items. Mobile based app 111 combines photos, descriptions, selected quantities, descriptions, and bundles them into a proposal report archived in, for example, main database 120 for access by various first, second, and third party users. Main database 120 also allows all parties to track progression of proposals from unsubmitted, submitted, approved, in progress, work completed, invoiced, and paid phases.

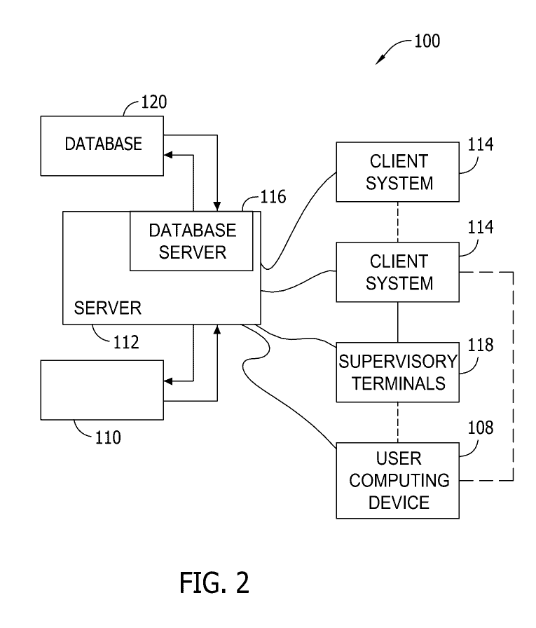

FIG. 2 is a simplified block diagram of services management system 100 including plurality of computer devices 108 including proposal generator 110 in accordance with one example embodiment of the present disclosure. In the example embodiment, the plurality of computer devices includes, for example, server system 212, client systems 214, and user computing device 108. In one embodiment, services management system 100 implements a process to manage generating and routing proposal 109 for services, documenting and invoicing maintenance activities, and managing inventory.

More specifically, in the example embodiment, services management system 100 includes a server system 212, and a plurality of client sub-systems, also referred to as client systems 214, connected to server system 212. In one embodiment, client systems 214 are computers including a web browser, such that server system 212 is accessible to client systems 214 using the Internet. Client systems 214 are interconnected to the Internet through many interfaces including a network, such as a local area network (LAN) or a wide area network (WAN), dial-in-connections, cable modems, and special high-speed Integrated Services Digital Network (ISDN) lines. Client systems 214 could be any device capable of interconnecting to the Internet including a web-based phone, PDA, or other web-based connectable equipment.

A database server 216 is communicatively coupled to a main or centralized database 120, which contains information on a variety of matters, as described below in greater detail. In one embodiment, centralized database 120 is stored on server system 212 and can be accessed by potential users at one of client systems 214 by logging onto server system 212 through one of client systems 214. In an alternative embodiment, database 120 is stored remotely from server system 212 and may be non-centralized.

Database 120 may include a single database having separated sections or partitions or may include multiple databases, each being separate from each other. Database 120 may store transaction data generated as part of sales activities conducted over the processing network including data relating to merchants, account holders or customers, issuers, acquirers, purchases made. Database 120 may also store account data including at least one of a client name, a client address, a property description associated with the client name, and other account identifier. Database 120 may also store employee data including an employee identifier that identifies each employee registered to use system 100. Database 120 may also store purchase data associated with items being purchased by a client from landscaping services provider 105, and items being purchased landscaping services provider 105 on behalf of a client. Database 120 may store picture files associated with the item or service, name, price, description, shipping and delivery information, instructions for facilitating the transaction, and other information to facilitate processing according to the method described in the present disclosure.

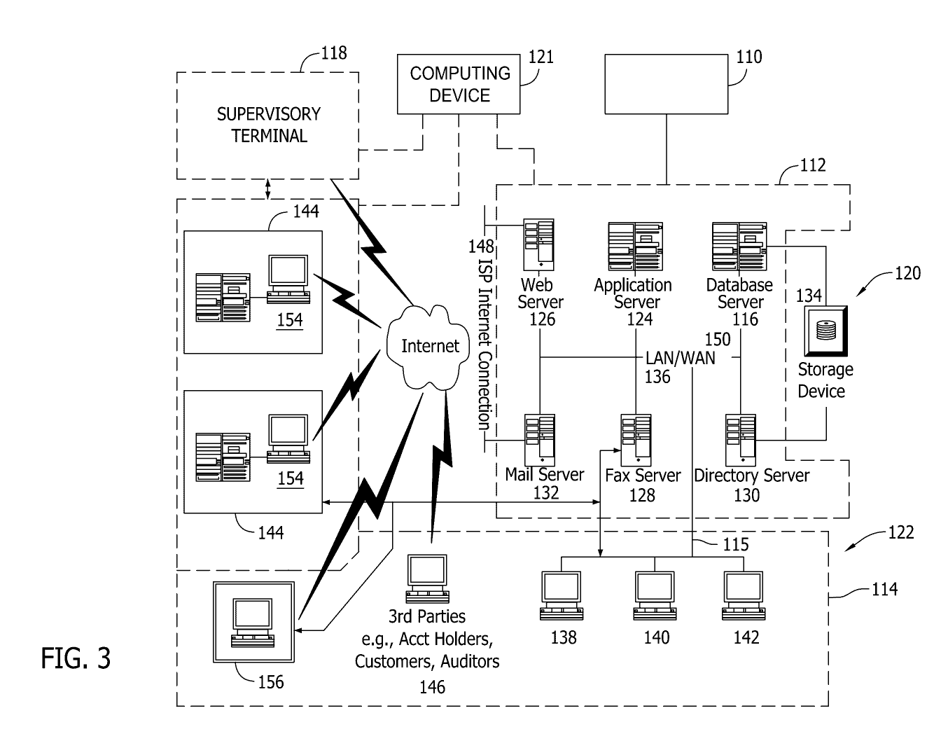

FIG. 3 is an expanded block diagram of services management system 100 shown in FIG. 2 in accordance with one example embodiment of the present disclosure. System 100 includes server system 212, client systems 214, supervisory terminal 118, and user computing device 108. Server system 212 further includes database server 216, an application server 124, a web server 126, a fax server 128, a directory server 130, and an email server 132.

Information bundled from app 111 including photos, links to view GPS selected map location markers, inventory descriptions, pricing, and quantities is then populated into a pre-formatted message, such as, but not limited to an email and is seamlessly and automatically sent to a respective client 106 including proposal 109. Each message uses links to view cloud-based map marker location files and proposal line item details. Clients 106 can access a pdf version of proposal files within the message as well, on demand. Instant one-click approvals are included within the message for client convenience. This one-click approval updates database 120 and changes the status of the proposal to approved.

A storage device 134 is coupled to database server 216 and directory server 130. Servers 216, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 212 is configured to be communicatively coupled to various individuals, including employees and to third parties, e.g., account holders, customers, auditors, developers, consumers, merchants, etc., using an ISP Internet connection 148. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the example embodiment, any authorized individual having a workstation 154 or user computing device 108 can access system 100. At least one of the client systems includes a manager workstation 156 located at a remote location. Workstations 154 and 156 are personal computers having a web browser. Also, workstations 154 and 156 are configured to communicate with server system 212. Furthermore, fax server 128 communicates with remotely located client systems, including a client system 156 using a telephone link. Fax server 128 is configured to communicate with other client systems 138, 140, and 142 as well.

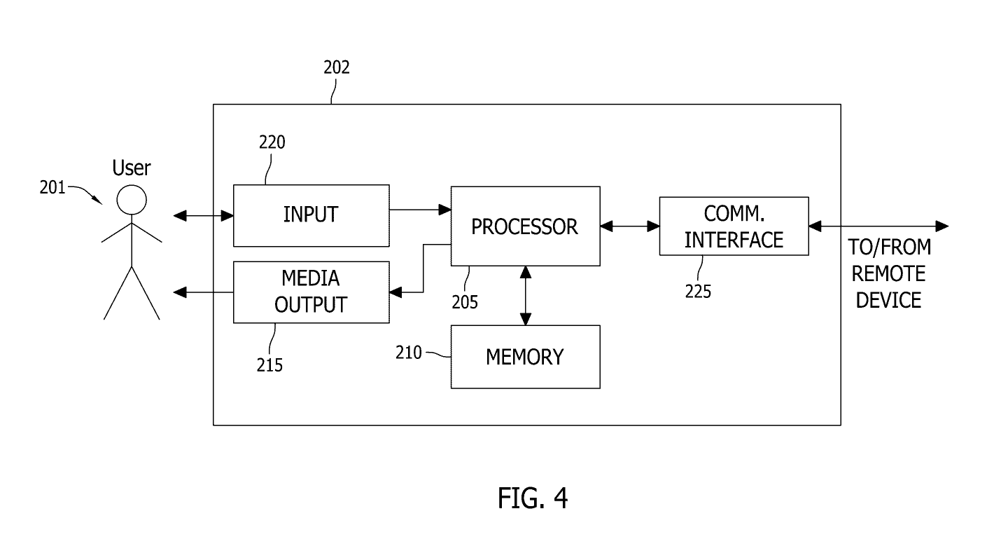

FIG. 4 illustrates an example configuration of a user system 202 operated by a user 201, such as field entity 102 (shown in FIG. 1). User system 202 may include, but is not limited to, client systems 214, 138, 140, and 142, supervisory terminal 118, user computing device 108, workstation 154, and manager workstation 156. In the example embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively couplable to a remote device such as server system 212. Communication interface 225 may include, for example, a wired or wireless network adapter or a wireless data transceiver for use with a mobile phone network, Global System for Mobile communications (GSM), 3G, 4G, LTE, or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser, and client application. Web browsers enable users, such as user 201, to display and interact with media and other information typically embedded on a web page or a website from server system 212. A client application allows user 201 to interact with a server application from server system 212.

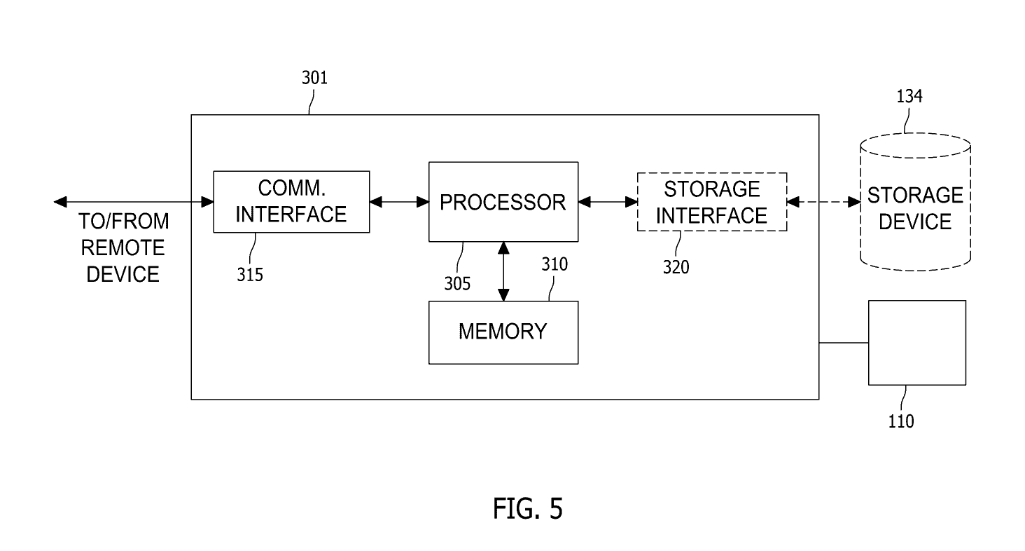

FIG. 5 illustrates an example configuration of a server system 301 such as server system 212 (shown in FIGS. 2 and 3). Server system 301 may include, but is not limited to, database server 216, application server 124, web server 126, fax server 128, directory server 130, and email server 132.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests from client system 214 via the Internet, as illustrated in FIGS. 2 and 3.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

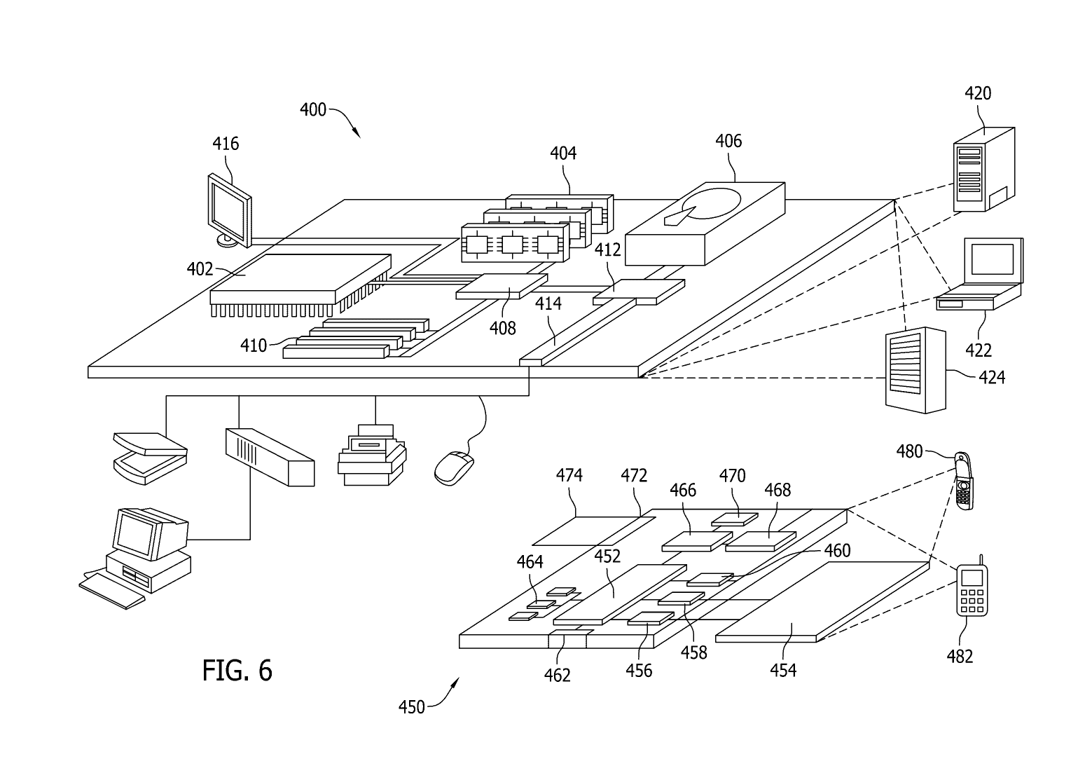

FIG. 6 is a block diagram of computing devices 400, 450, in accordance with another embodiment, that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In some implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In some implementations, the memory 404 is a computer-readable medium. In some implementations, the memory 404 is a volatile memory unit or units. In other implementations, the memory 404 is a non-volatile memory unit or units.

The storage device 406 is capable of providing mass storage for the computing device 400. In some implementations, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In some implementations, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high-speed controller 408 manages bandwidth-intensive operations for the computing device 400, while the low speed controller 412 manages lower bandwidth-intensive operations. Such allocation of duties is exemplary only. In some implementations, the high-speed controller 408 is coupled to memory 404, display 416 (e.g., through a graphics processor or accelerator), and to high-speed expansion ports 410, which may accept various expansion cards (not shown). In some implementations, low-speed controller 412 is coupled to storage device 406 and low-speed expansion port 414. The low-speed expansion port, which may include various communication ports (e.g., USB, Bluetooth™, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, and an input/output device such as a display 454, a communication interface 466, and a transceiver 468, among other components. The device 450 may also be provided with a storage device, such as a Microdrive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of device 450 with other devices. External interface 462 may provide, for example, for wired communication (e.g., via a docking procedure) or for wireless communication (e.g., via Bluetooth or other such technologies).

The memory 464 stores information within the computing device 450. In some implementations, the memory 464 is a computer-readable medium. In some implementations, the memory 464 is a volatile memory unit or units. In some implementations, the memory 464 is a non-volatile memory unit or units. Expansion memory 474 may also be provided and connected to device 450 through expansion interface 472, which may include, for example, a SIM card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provide as a security module for device 450, and may be programmed with instructions that permit secure use of device 450. In addition, secure applications may be provided via the SIM cards, along with additional information, such as placing identifying information on the SIM card in a non-hack able manner.

The memory may include for example, flash memory and/or MRAM memory, as discussed below. In some implementations, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Device 450 may communicate wirelessly through communication interface 466, which may include digital signal processing circuitry where necessary. Communication interface 466 may provide for communications under various modes or protocols, such as GSM voice calls, SMS, EMS, or MIMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, Wi-Fi, or other such transceiver (not shown). In addition, GPS receiver module 470 may provide additional wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, etc.), and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other similar mobile device.

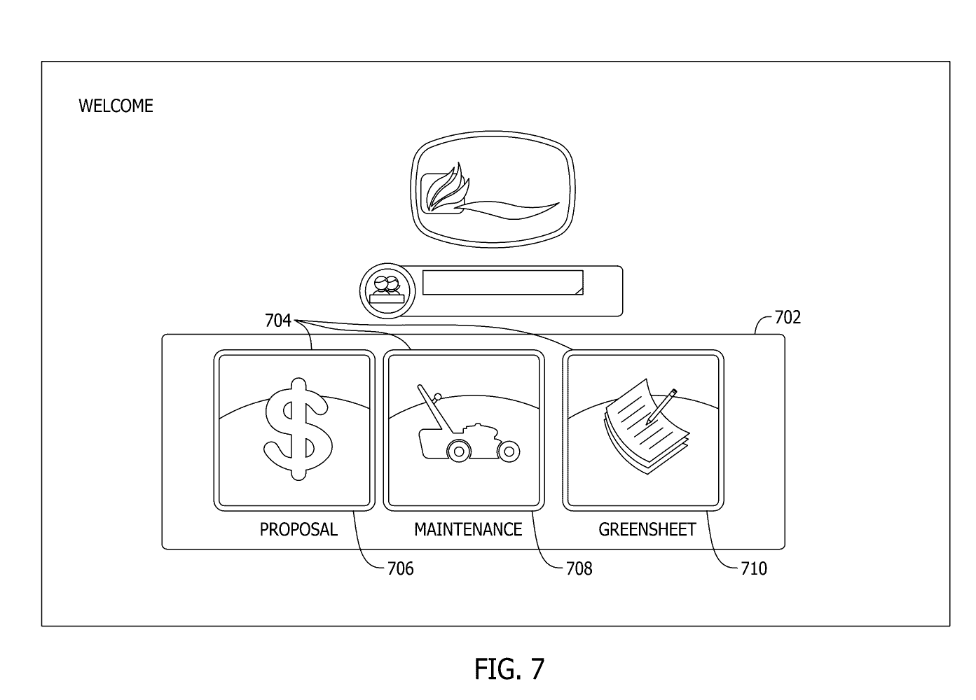

FIG. 7 is a screen capture of a welcome display 700 of user computing device 108 of services management system 100 (shown in FIG. 1). In the example embodiment, welcome display 700 includes a selection portion 702 including a plurality of virtual buttons 704 configured to direct a user to a selected area of services management system 100. A proposal button 706 directs the user to a proposal generating and management area, a maintenance button directs the user to a maintenance management area, and a greensheet button 710 directs the user to an inventory and accounting interface area. With each selection the user is directed through a logical progression of building proposal 109 for a scope of work observed at a jobsite.

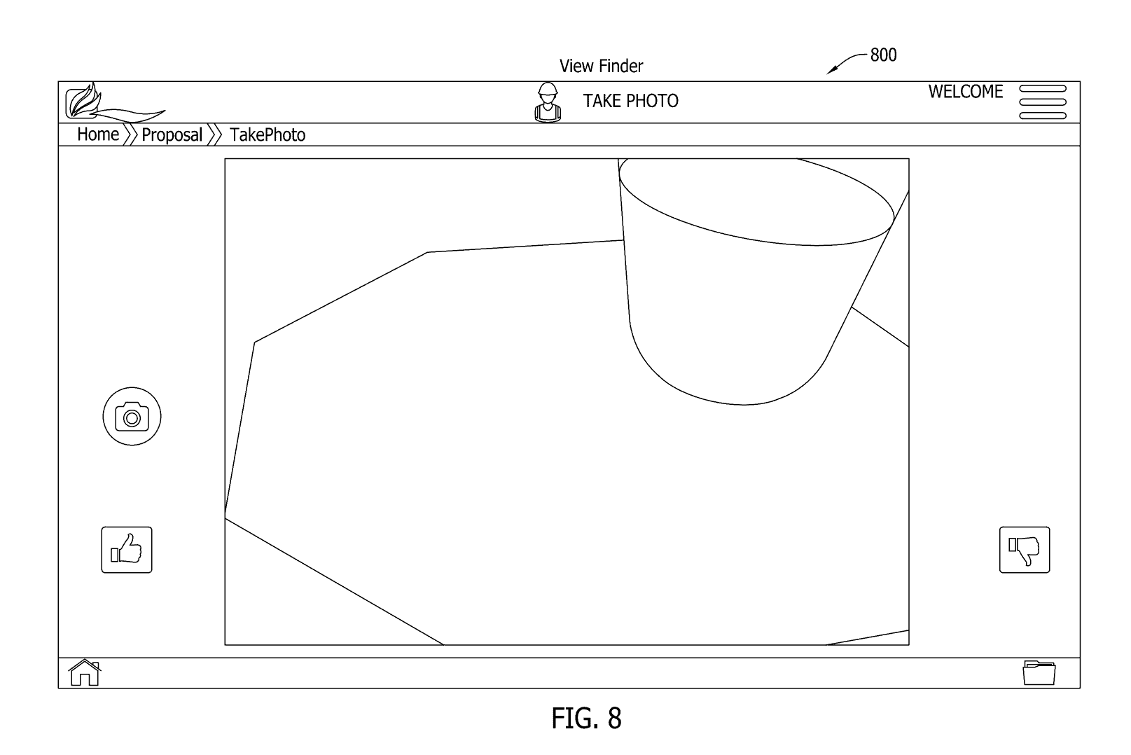

FIG. 8 is a screen capture of a camera viewfinder display 800 of user computing device 108 in accordance with an example embodiment of the present disclosure. In the example embodiment, to generate proposal 109, a photo of a proposed scope of work is acquired by for example, field entity 102, such as a job foreman at the site of the proposed work. In various embodiments, a photo may be acquired at a different time than when preparing proposal 109 and may be acquired using any photo acquisition equipment. In some embodiments, a photo may be sent electronically to user computing device 108 and imported for use in generating proposal 109.

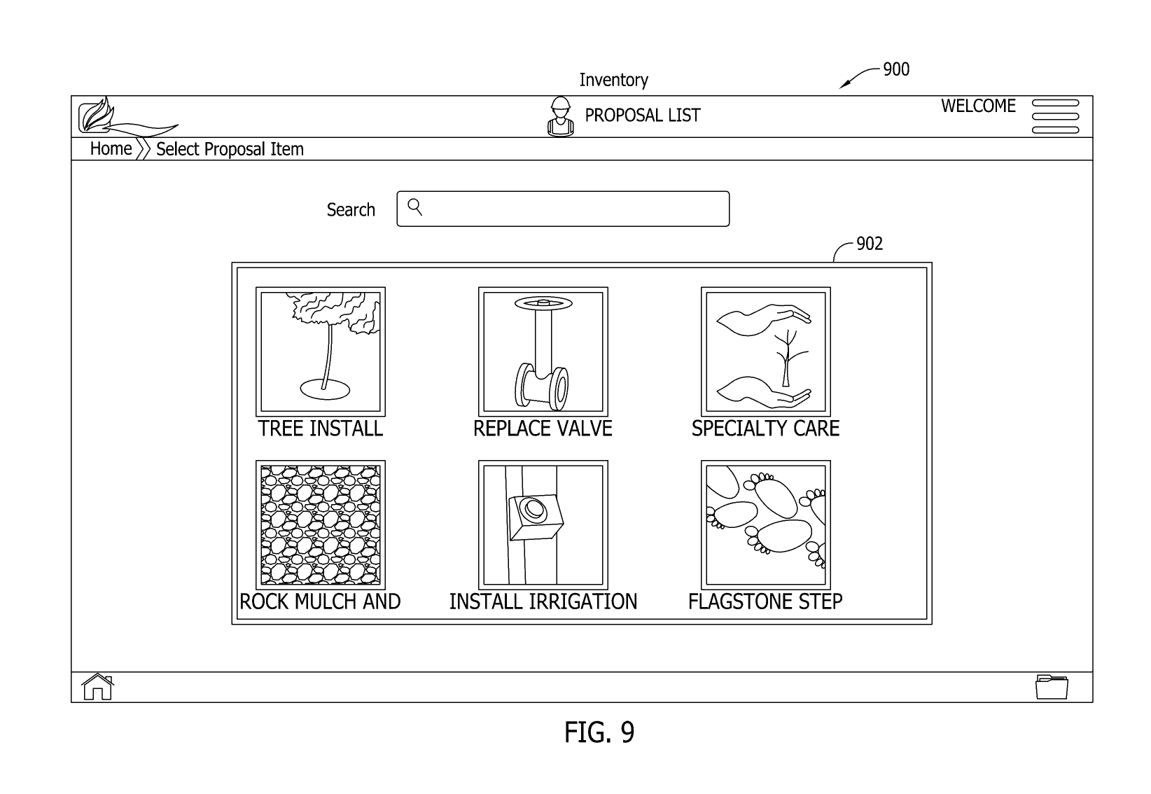

FIG. 9 is a screen capture of a proposal list selection menu display 900 that includes a proposal selection menu 902. In the example embodiment, proposal selection menu 902 includes icons that graphically illustrate, in language independent indicia, a predetermined scope of work. The language independent indicia includes photos, international symbols, art work representations of the scope of work, or any other graphic that is readily understood and associated with the predetermined scope of work. The language independent indicia permit, for example, a non-English speaker to generate proposal 109 in English for English speaking supervisory personnel and/or clients.

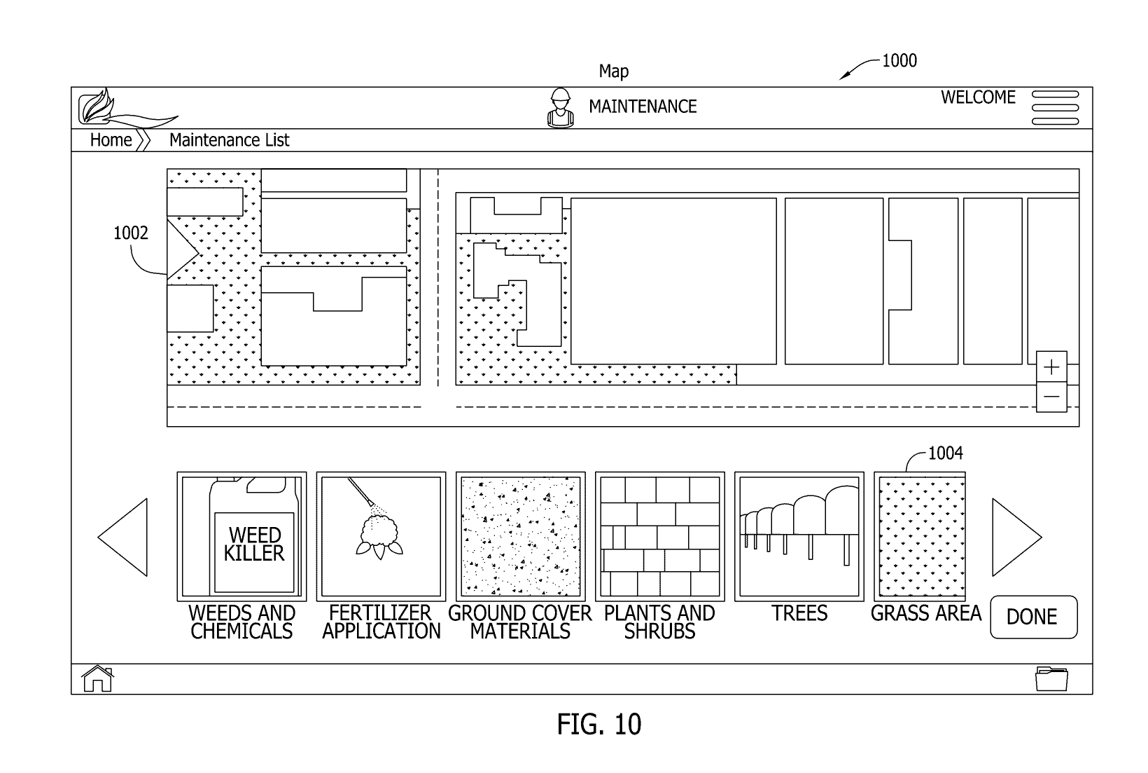

FIG. 10 is a screen capture of a maintenance list display screen 1000. In the example embodiment, maintenance list display screen 1000 includes an overhead or plan view 1002 of the area to be maintained, for example, a satellite view or a map view of an area where periodic landscape maintenance has already been contracted to be performed. User computing device 108 is used to document a performance of routine or periodic maintenance. A maintenance activity selection menu 1004 includes icons that graphically illustrate, in language independent indicia, a predetermined maintenance activity. The language independent indicia includes photos, international symbols, art work representations of the maintenance activity, or any other graphic that is readily understood and associated with the predetermined scope of work.

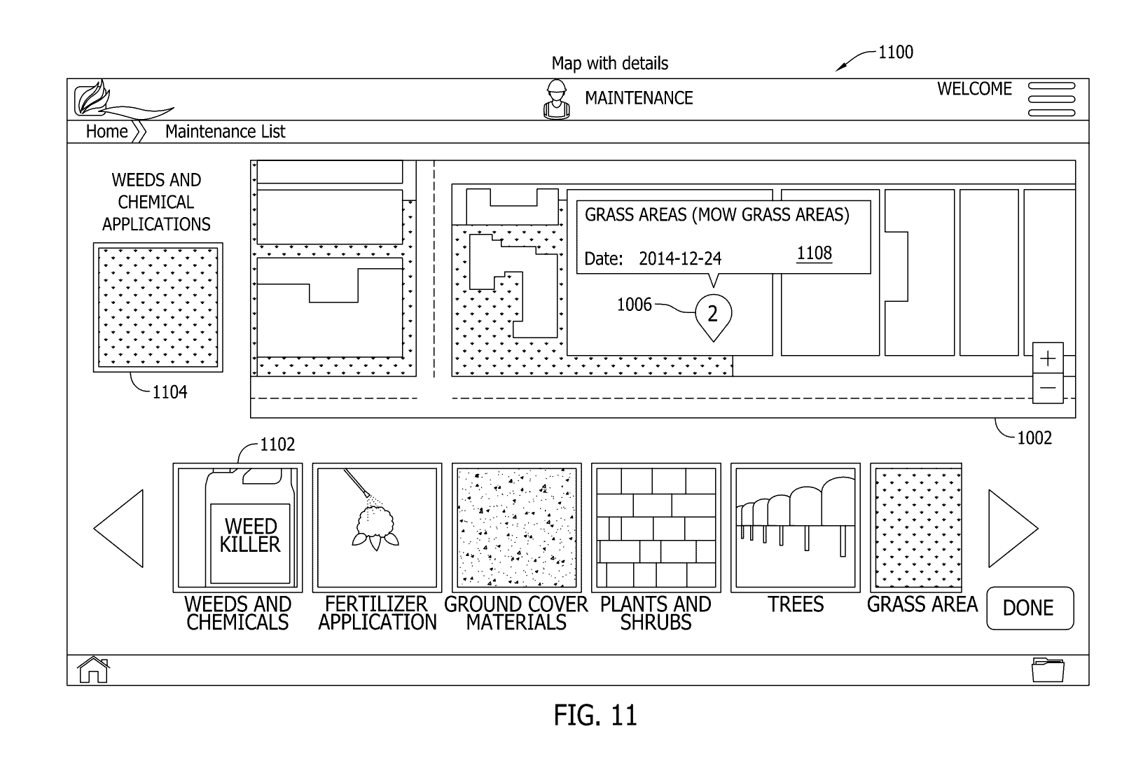

FIG. 11 is another screen capture of maintenance list display screen 1000. In the example embodiment, a weeds and chemical maintenance activity 1102 has been selected. A task icon 1104 is displayed proximate plan view 1002 and a task locator icon 1106 is displayed on plan view 1002 at the location of the maintenance activity. A maintenance activity popup notes window 1108 opens to receive edits to the associated maintenance activity, if necessary.

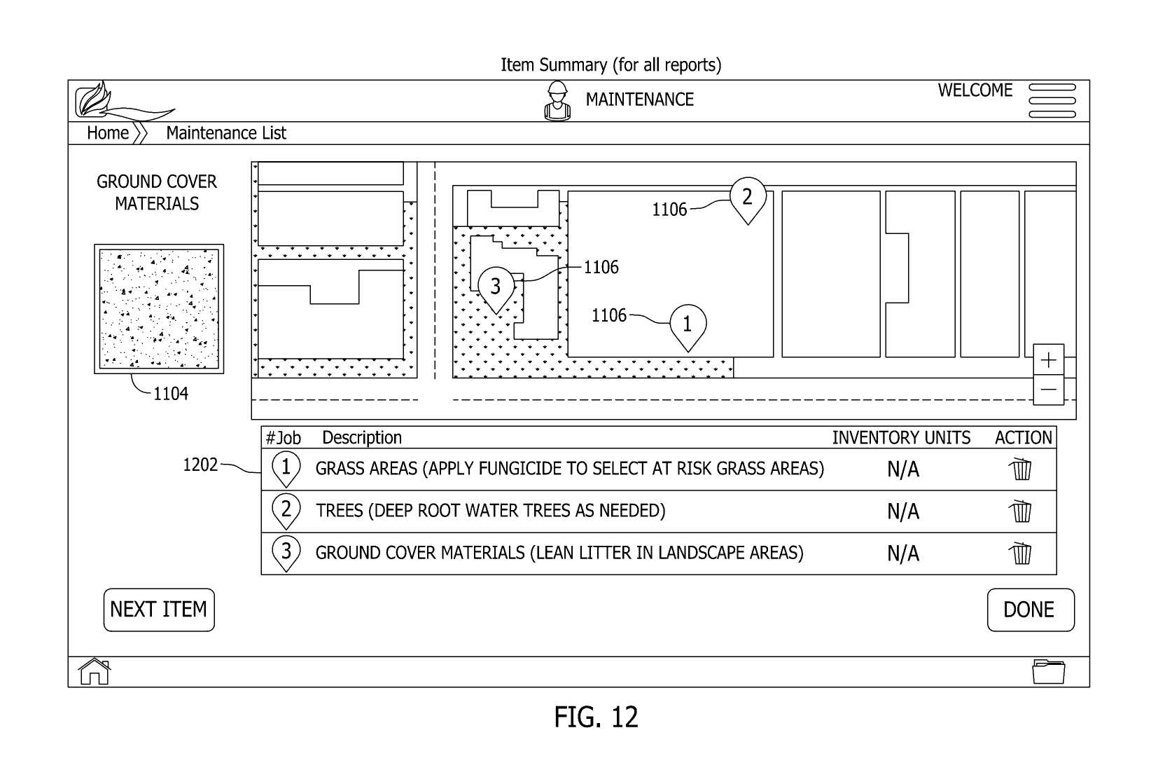

FIG. 12 is another screen capture of maintenance list display screen 1000 indicating a list 1202 of maintenance activities to be performed. Each item in list 1202 includes an associated icon task locator icon 1106, which, when selected either at task locator icon 1106 or in list 1202, displays task icon 1104 associated with that maintenance activity. List 1202 is used to document performance of the maintenance activities.

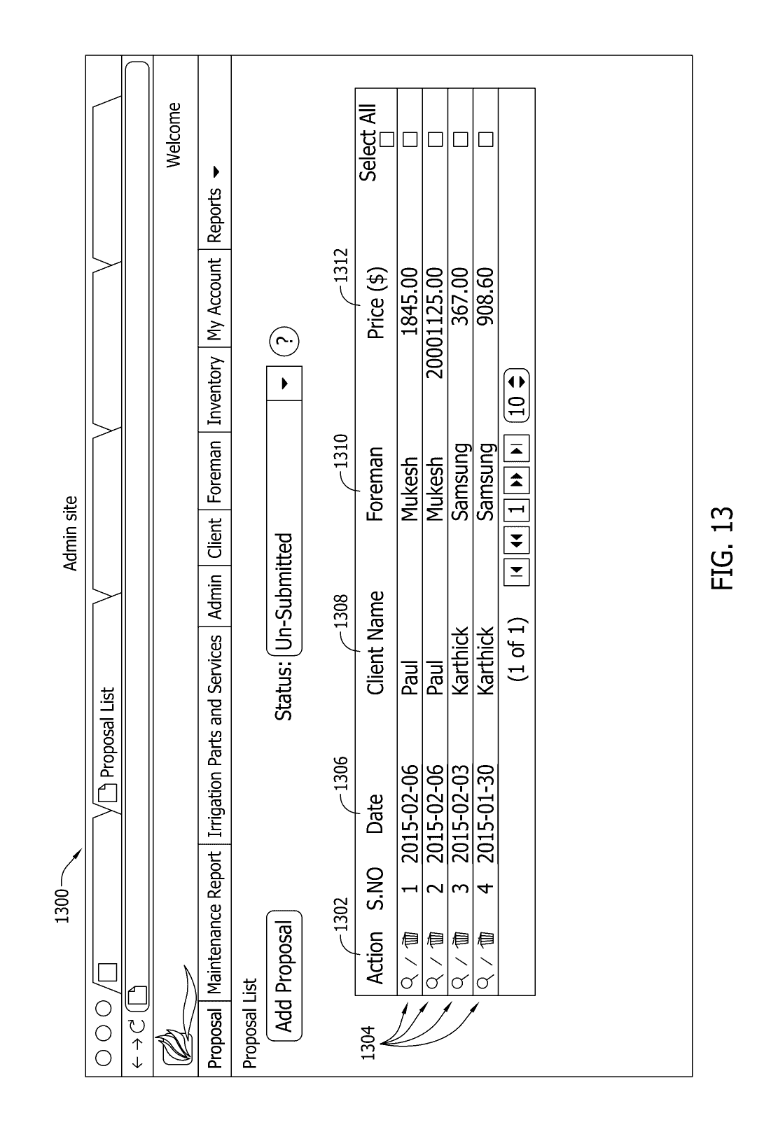

FIG. 13 is a screen capture of an admin site page 1300 of services management system 100. In the example embodiment, admin site page 1300 includes an action column 1302 providing icons indicating actions that can be taken with respect to the associated entry 1304. Admin site page 1300 also includes a date column 1306 indicating a date associated with associated entry 1304. The date in date column 1306 may represent a date of origination, a date due, a date of expected work completion, and the like. Admin site page 1300 further includes a client column 1308, a foreman column 1310, and a price column 1312. Admin site page 1300 is a gateway to other web pages regarding proposals.

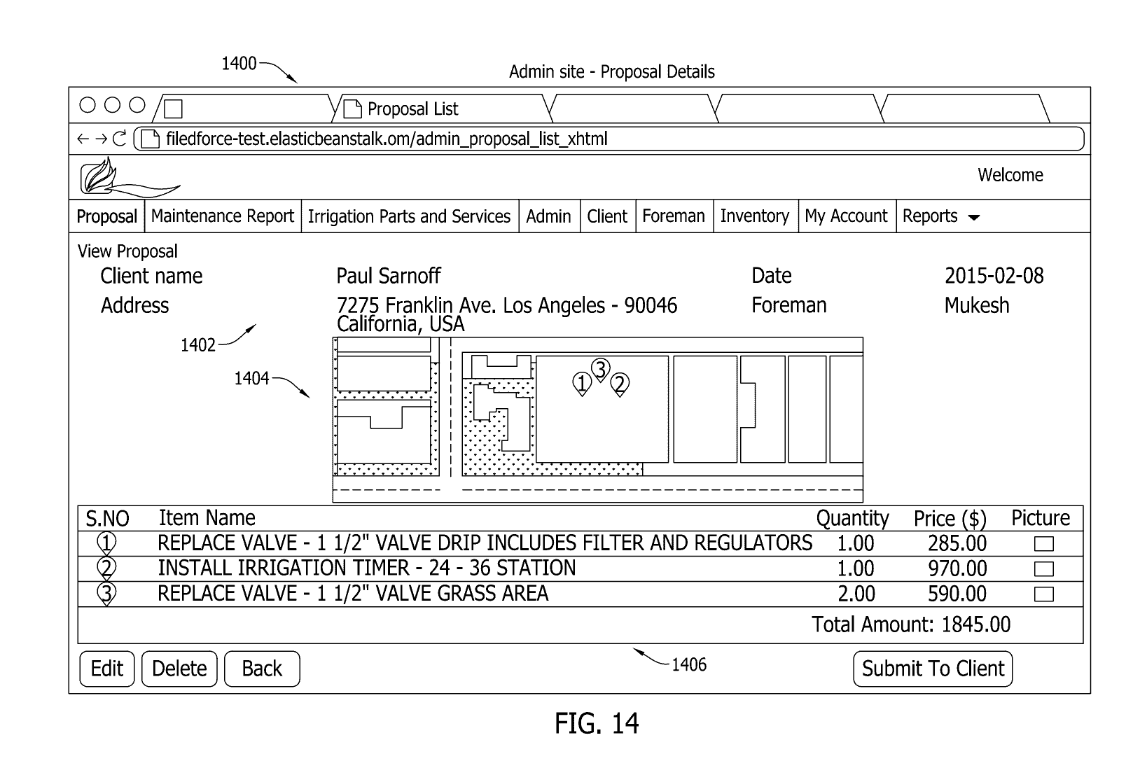

FIG. 14 is a screen capture of an admin site proposal detail page 1400 of services management system 100. In the example embodiment, admin site proposal detail page 1400 includes a proposal information area 1402, a graphical map area 1404 of the location covered by the proposal, and a scope of work area 1406 that details the tasks, replacement parts used, and/or tools used that are charged for.

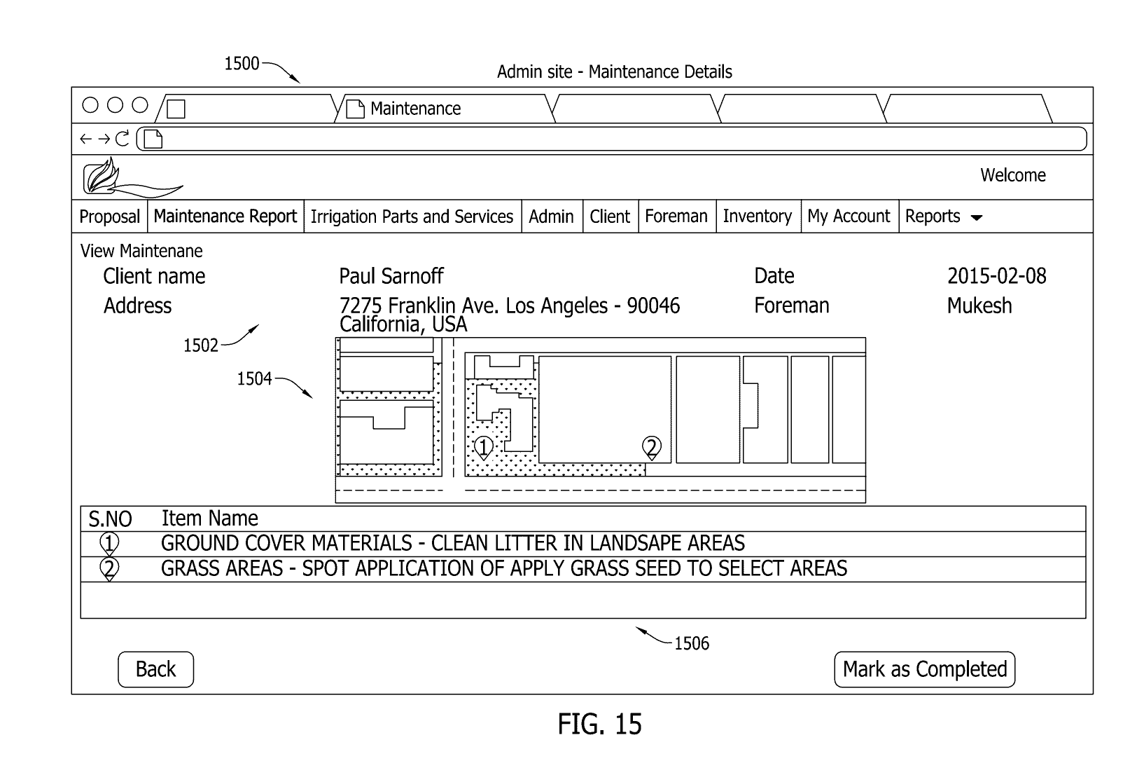

FIG. 15 is a screen capture of an admin site maintenance details page 1500 of services management system 100. In the example embodiment, admin site maintenance details page 1500 includes a maintenance task detail area 1502, a graphical map area 1504 of the location covered by the maintenance tasks, and a maintenance task list area 1506 that details the maintenance tasks to be accomplished. Selecting a maintenance task entry opens another web page that details the activities, tools needs, parts required, and step-by-step instructions for accomplishing the selected task item.

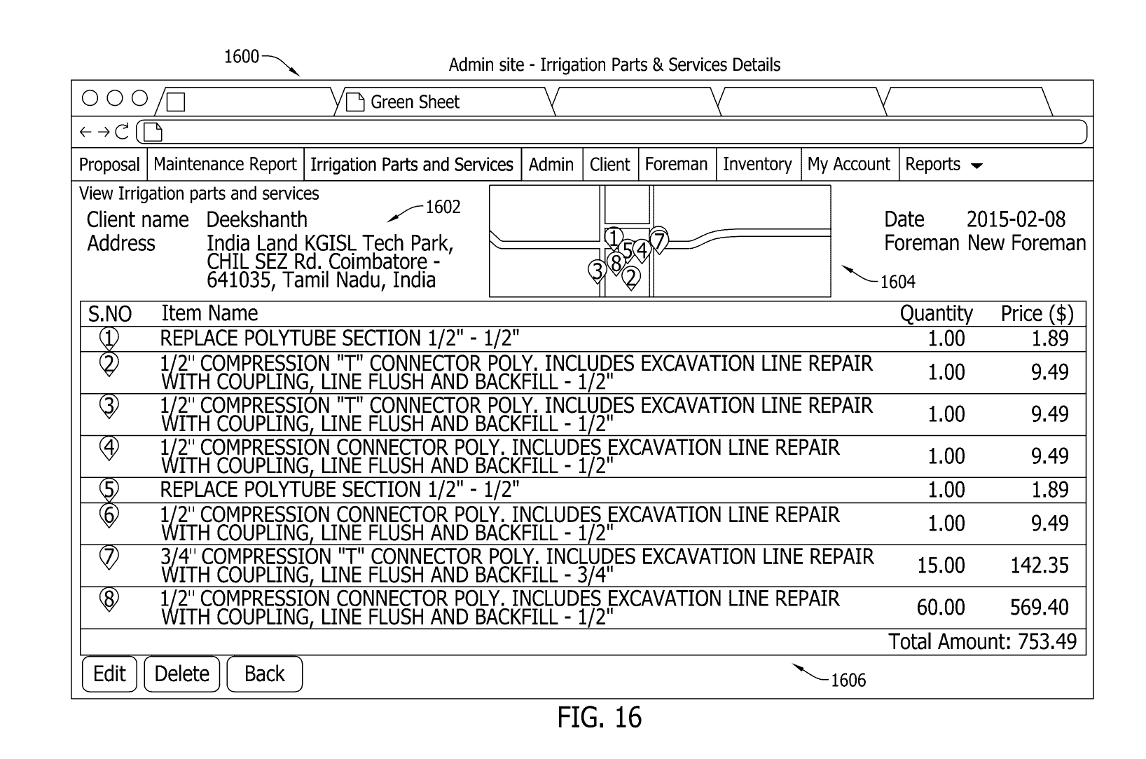

FIG. 16 is a screen capture of an admin site irrigation parts and service detail page 1600 of services management system 100. In the example embodiment, admin site irrigation parts and service detail page 1600 includes an irrigation parts and service area 1602, a graphical map area 1604 of the location covered by the irrigation parts and service area, and a scope of work area 1606 that details the irrigation tasks, replacement parts available and/or required to complete the prescribed tasks.

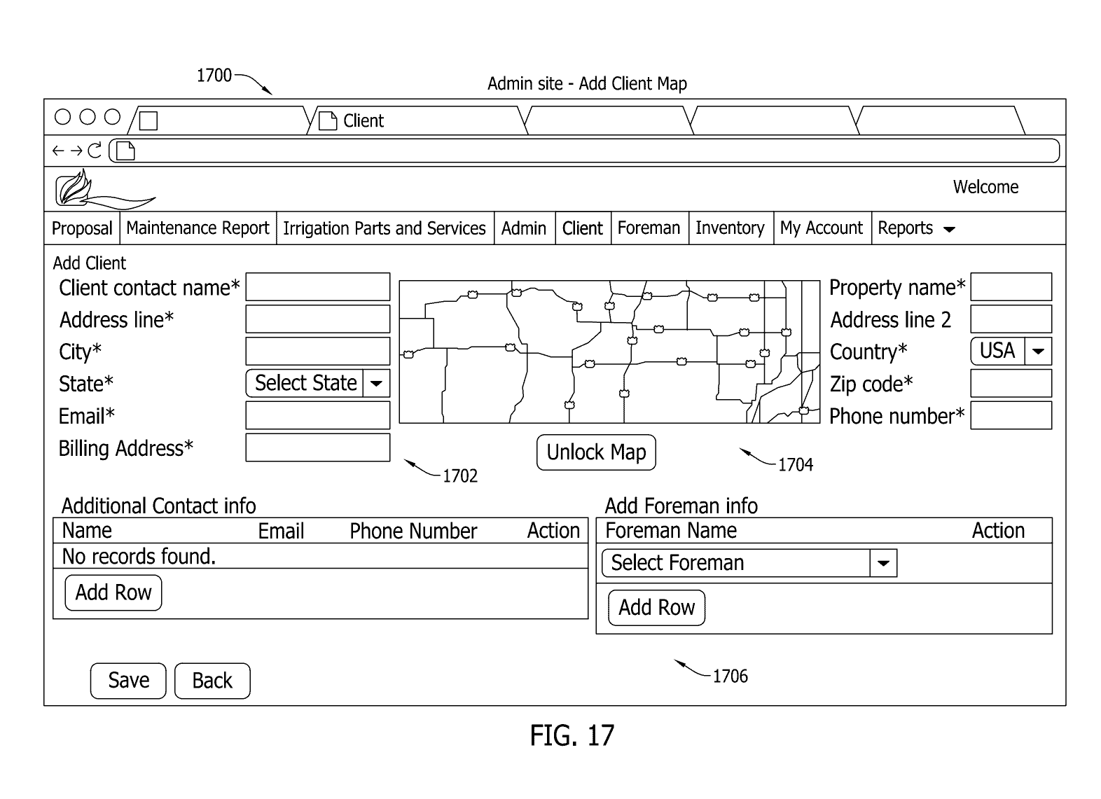

FIG. 17 is a screen capture of an admin site add client map page 1700. In the example embodiment, admin site add client map page 1700 includes a client information entry area 1702, a graphical map area 1704 of the location covered by the client. Many clients will have more than one location where work will be performed. Admin site add client map page 1700 permits entering more than one location per client. Admin site add client map page 1700 also includes an additional information and a foreman assignment area 1706. The additional information may include special instructions, local contact protocols, gate access codes, and the like. The foreman assignment area can be used to temporarily reassign areas to different foremen, for example, in the case of one foreman being absent due to illness or vacation.

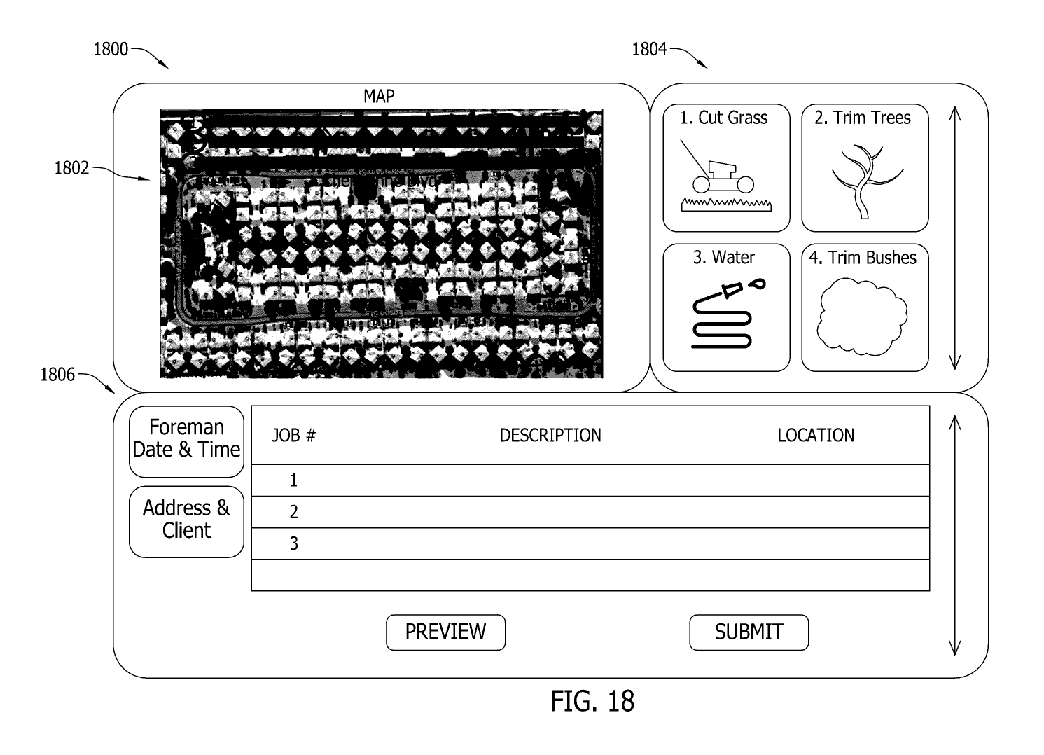

FIG. 18 is a screen capture of a maintenance task entry page 1800 of services management system 100. In the example embodiment, maintenance task entry page 1800 includes a map area 1802 that indicates the area where the maintenance tasks will be performed. Specific areas can be indicated by pointing using the touch screen to enclose the area. The selected area can be left in a free-form indicated area or the selected area can be set to snap to a grid. A maintenance task selection area 1804 permits selection of graphic icons representing maintenance tasks to be associated with the area selected in map area 1802. The use of icons to represent maintenance tasks permits field entities 102 who do not have significant language skills in the language in which proposal 109 will be generated to provide the required input without language assistance. In some embodiments, selecting an icon will open another window of more specific icons to select from. For example, “2. Trim Trees” is a very broad task specifier. Different trees can represent significantly different scopes of work for trimming them. For example, a fruit tree may be able to be trimmed and/or pruned while the worker is standing on the ground. However, trimming a palm tree may require the use of a bucket truck or manlift to accomplish. Accordingly, “2. Trim Trees” by itself could represent significantly different scopes of work. Maintenance task entry page 1800 also includes a task generation workspace 1806 that permits building each job or task that is to be performed at a location represented by map area 1802.

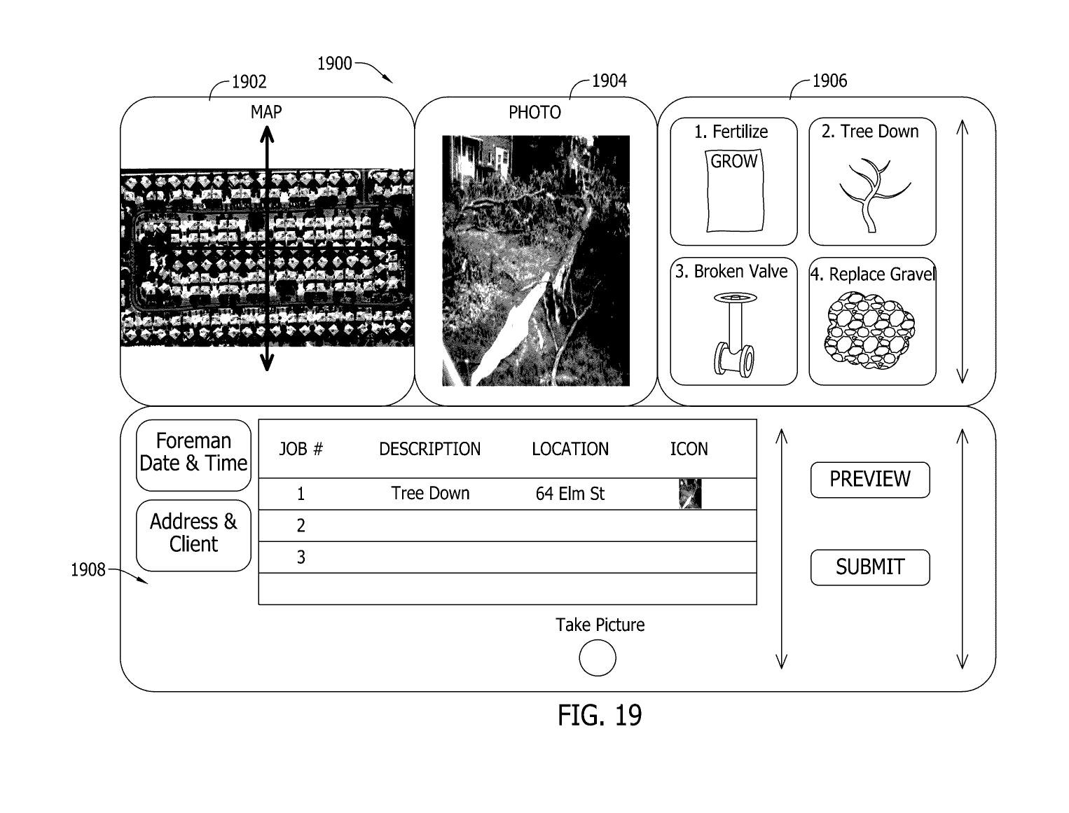

FIG. 19 is a screen capture of an admin site damage repair task entry page 1900. In the example embodiment, damage repair task entry page 1900 includes a map area 1902 for specifying the location of damage. A photo area 1904 permits acquiring and displaying a photo of the damage. A repair task selection area 1906 permits selection of graphic icons representing repair tasks to be associated with the area selected in map area 1902. A repair task generation workspace 1908 permits building each repair job or task that is to be performed at a location indicated on map area 1902.

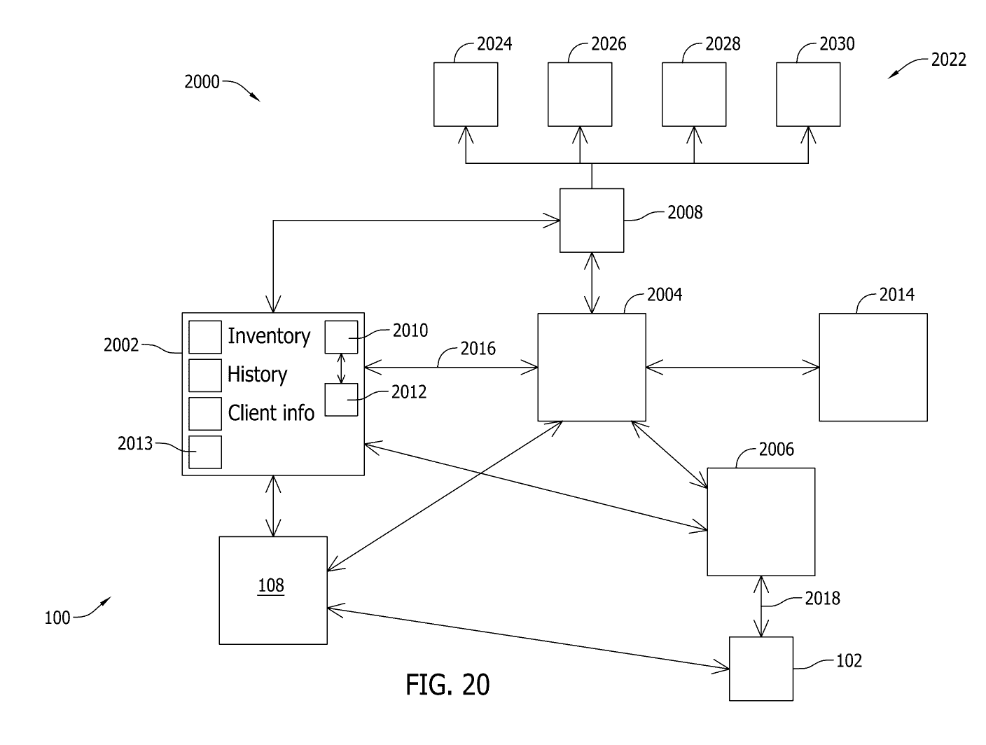

FIG. 20 is a block data flow diagram 2000 of services management system 100 (shown in FIG. 1). In the example embodiment, services management system 100 includes a main database manager 2002, an inventory component 2004, a proposal generator component 2006, and a communication component 2008.

Main database manager 2002 includes a main database 2010 and a processor 2012 communicatively coupled to main database 2010. Main database manager 2002 is communicatively coupled to a plurality of entities of services management system 100. Main database manager 2002 is configured to receive an approved proposal, convert the approved proposal to a work order, automatically populate fields of the work order based on the approved proposal, determine tasks of the work order from a plurality of defined tasks stored in main database manager 2002, and output an alert for tasks of the work order that do not match any of the defined tasks.

Main database manager 2002 further comprises a predictor component 2013 configured to receive a query request from a component of said services management system, determine a currency of a stored query result from a previous query from the component, and execute the query request if the stored query result lacks a predetermined currency. Predictor component 2013 is further configured to automatically execute a historical received query request when the currency of the respective stored query result is outside a predetermined currency range.

Inventory component 2004 is communicatively coupled to a vendor entity 2014 of the plurality of entities and is configured to receive hardware usage data 2016 from main database manager 2002. Inventory component 2004 is configured to determine seasonally appropriate inventory levels for each item of hardware used based on the received hardware usage data. Inventory component 2004 is also configured to predict future hardware usage, predict a time until inventory runout based on current inventory levels and the predicted future hardware usage, and replenish inventory levels prior to the predicted inventory runout. Inventory component 2004 is further configured to initiate a purchase of a volume of hardware that yields optimal pricing based on the predicted future hardware usage and the predicted time until inventory runout.

Proposal generator component 2006 is configured to receive manual inputs 2018 from a user, such as, field entity 102 at a work site. In the example embodiment, manual inputs 2018 include at least one of a photo of a scope of work and a graphic icon representing a task. Proposal generator component 2006 is also configured to determine information required to generate a proposal 2020, transmit a request to main database manager 2002 for the determined information, receive the requested information and generate proposal 2020 based on manual inputs 2018 and the received information. Proposal generator component 2006 is configured to include at least one of a work site location, a work site owner, a responsible work foreman, a responsible business manager of the work site in a generated proposal.

Communication component 2008 is configured to transmit and track a status of generated proposal 2020. Communication component 2008 is configured to automatically determine, from the contents of the generated proposal, a routing list of approving parties 2022 of the generated proposal, transmit the generated proposal to each of the approving parties 2022 in a hierarchical order and track a status of said generated proposal during the routing, and transmit a reminder message to an approving party 2022 after a predetermined time period with no response from the approving party 2022. In various embodiments, approving parties 2022 include, for example, but not limited to, a supervisor 2024 of field entities 102, a client 2026, a business presentative 2028 associated with client 2026, or an agent of client 2026.

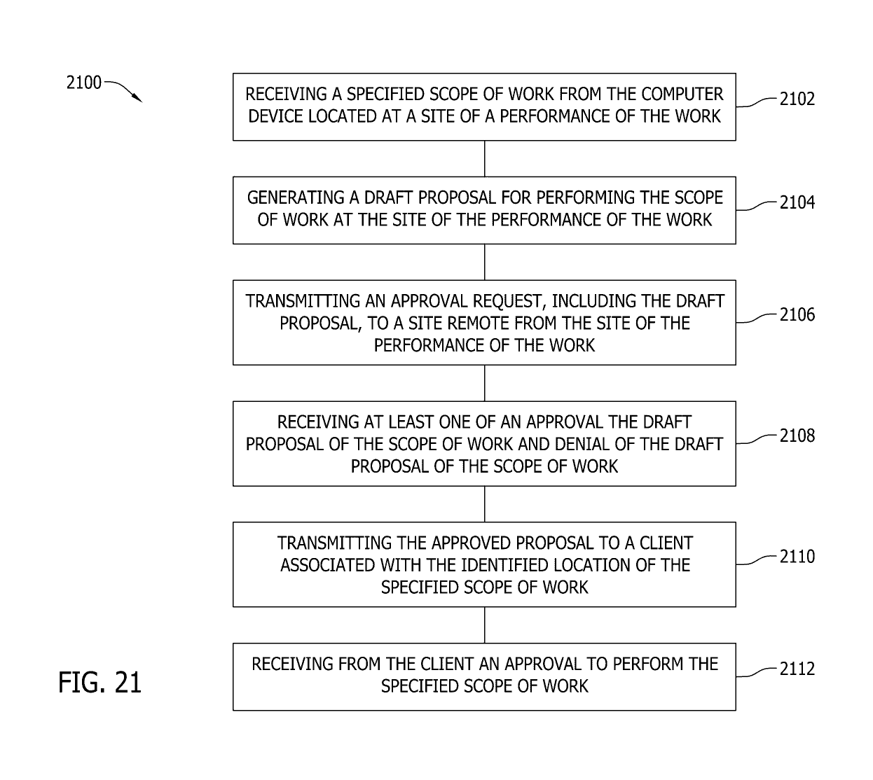

FIG. 21 is a flow chart of a computer-implemented method 2100 for managing services using a computer device coupled to a user interface and a memory device. In the example embodiment, method 2100 includes receiving 2102 a specified scope of work from the computer device located at a site of a performance of the work, generating 2104 a draft proposal for performing the scope of work at the site of the performance of the work, and transmitting 2106 an approval request, including the draft proposal, to a site remote from the site of the performance of the work. Method 2100 also includes receiving 2108 at least one of an approval the draft proposal of the scope of work and denial of the draft proposal of the scope of work, transmitting 2110 the approved proposal to a client associated with the identified location of the specified scope of work, and receiving 2112 from the client an approval to perform the specified scope of work.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

User computing device 108 may include any devices capable of receiving information from network 107. User computing device 108 could include general computing components and/or embedded systems optimized with specific components for performing specific tasks. Examples of user access devices include personal computers (e.g., desktop computers), mobile computing devices, cell phones, smart phones, media players/recorders, music players, game consoles, media centers, media players, electronic tablets, personal digital assistants (PDAs), television systems, audio systems, radio systems, removable storage devices, navigation systems, set top boxes, other electronic devices and the like. User computing device 108 can also include various other elements, such as processes running on various machines.

Network 107 may include any element or system that facilitates communications among and between various network nodes, such as elements 108, 212, 214 and 216. Network 107 may include one or more telecommunications networks, such as computer networks, telephone, or other communications networks, the Internet, etc. Network 107 may include a shared, public, or private data network encompassing a wide area (e.g., WAN) or local area (e.g., LAN). In some implementations, network 107 may facilitate data exchange by way of packet switching using the Internet Protocol (IP). Network 107 may facilitate wired and/or wireless connectivity and communication.

Services management system 100 further includes a website including one or more resources (e.g., text, images, multimedia content, and programming elements, such as scripts) associated with a domain name and hosted by one or more servers. Resources can be relatively static (e.g., as in a publisher's webpage) or dynamically generated in response to user query (e.g., as in a search engine's result page).

For purposes of explanation only, certain aspects of this disclosure are described with reference to the discrete elements illustrated in FIG. 1. The number, identity, and arrangement of elements in services management system 100 are not limited to what is shown. For example, services management system 100 can include any number of geographically-dispersed field entities 102, services entity servers 104 and/or user computing devices 108, which may be discrete, integrated modules or distributed systems. Similarly, services management system 100 is not limited to a single services entity server system 104 and may include any number of integrated or distributed services entity servers 104 or elements.

Furthermore, additional and/or different elements not shown may be contained in or coupled to the elements shown in FIG. 1, and/or certain illustrated elements may be absent. In some examples, the functions provided by the illustrated elements could be performed by less than the illustrated number of components or even by a single element. The illustrated elements could be implemented as individual processes run on separate machines or a single process running on a single machine.

The foregoing detailed description illustrates embodiments of the disclosure by way of example and not by way of limitation. It is contemplated that the disclosure has general application to the review and revision of advertisements. It is further contemplated that the methods and systems described herein may be incorporated into existing online advertising planning systems, in addition to being maintained as a separate stand-alone application.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In the example embodiment, computing systems 500 and 552 are configured to receive and/or retrieve data pertaining to the creation, review and revision of services proposals 109 from various other computing devices connected to computing devices 500 and 552 through a communication network, and store this data within at least one of memory 504, storage device 506, and memory 564. Computing systems 500 and 552 are further configured to manage and organize the data within at least one of memory 504, storage device 506, and memory 564 using the techniques described herein.

The logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement the disclosure or its features may have different names, formats, or protocols. Further, the system may be implemented via a combination of hardware and software, as described, or entirely in hardware elements. Also, the particular division of functionality between the various system components described herein is merely one example, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments of the disclosure may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the disclosure. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device, and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “computer” and related terms, e.g., “computing device”, are not limited to integrated circuits referred to in the art as a computer, but broadly refers to a microcontroller, a microcomputer, a programmable logic controller (PLC), an application specific integrated circuit, and other programmable circuits, and these terms are used interchangeably herein.

As used herein, the term “cloud computing” and related terms, e.g., “cloud computing devices” refers to a computer architecture allowing for the use of multiple heterogeneous computing devices for data storage, retrieval, and processing. The heterogeneous computing devices may use a common network or a plurality of networks so that some computing devices are in networked communication with one another over a common network but not all computing devices. In other words, a plurality of networks may be used in order to facilitate the communication between and coordination of all computing devices.

As used herein, the term “mobile computing device” refers to any of computing device which is used in a portable manner including, without limitation, smart phones, personal digital assistants (“PDAs”), computer tablets, hybrid phone/computer tablets (“phablet”), or other similar mobile device capable of functioning in the systems described herein. In some examples, mobile computing devices may include a variety of peripherals and accessories including, without limitation, microphones, speakers, keyboards, touchscreens, gyroscopes, accelerometers, and metrological devices. Also, as used herein, “portable computing device” and “mobile computing device” may be used interchangeably.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processors 205,305, 402, 452 and by devices that include, without limitation, mobile devices, clusters, personal computers, workstations, clients, and servers, including RAM memory, ROM memory, EPROM memory, EEPROM memory, and non-volatile RAM (NVRAM) memory. The above memory types are examples only, and are thus not limiting as to the types of memory usable for storage of a computer program.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

Many of the functional units described in this specification have been labeled as modules, in order to more particularly emphasize their implementation independence. For example, a module may be implemented as a hardware circuit comprising custom very large scale integration (“VLSI”) circuits or gate arrays, off-the-shelf semiconductors such as logic chips, transistors, or other discrete components. A module may also be implemented in programmable hardware devices such as field programmable gate arrays (FPGAs), programmable array logic, programmable logic devices (PLDs), or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A services management system comprising:
a main database manager comprising a main database and a processor communicatively coupled to the main database, said main database manager communicatively coupled to a plurality of entities in said services management system;
an inventory component communicatively coupled to a vendor entity of the plurality of entities, said inventory component configured to receive hardware usage data from said main database manager;
a proposal generator configured to:
receive manual inputs from a user at a work site, said manual inputs comprising at least one of a photo of a scope of work and a graphic icon representing a task;
determine information required to generate a proposal;
transmit a request to said main database manager for the determined information;
receive the requested information;
generate said proposal based on the manual inputs and the received information; and
a communication component configured to transmit and track a status of said generated proposal.

2. The system of claim 1, wherein said inventory component is configured to determine seasonally appropriate inventory levels for each item of hardware used based on the received hardware usage data;

3. The system of claim 1, wherein said inventory component is configured to:
predict future hardware usage;
predict a time until inventory runout based on current inventory levels and the predicted future hardware usage; and
replenish inventory levels prior to the predicted inventory runout.

4. The system of claim 1, wherein said inventory component is configured to initiate a purchase of a volume of hardware that yields optimal pricing based on the predicted future hardware usage and the predicted time until inventory runout.

5. The system of claim 1, wherein said proposal generator is configured to include at least one of a work site location, a work site owner, a responsible work foreman, a responsible business manager of the work site, said communication component is configured to:
automatically determine, from the contents of the generated proposal, a routing list of approving parties of the generated proposal;
transmit the generated proposal to each of the approving parties in a hierarchical order and track a status of said generated proposal during the routing; and
transmit a reminder message to an approving party after a predetermined time period with no response from the approving party.

6. The system of claim 1, wherein said main database manager further comprises a predictor component configured to:
receive a query request from a component of said services management system;
determine a currency of a stored query result from a previous query from the component; and
execute the query request if the stored query result lacks a predetermined currency.

7. The system of claim 6, wherein said predictor component is further configured to automatically execute a historical received query request when the currency of the respective stored query result is outside a predetermined currency range.

8. The system of claim 1, wherein said main database manager is configured to:
receive an approved proposal;
convert the approved proposal to a work order;
automatically populate fields of the work order based on the approved proposal;
determine tasks of the work order from a plurality of defined tasks stored in said main database manager; and
output an alert for tasks of the work order that do not match any of the defined tasks.

9. One or more non-transitory computer-readable storage media having computer-executable instructions embodied thereon, wherein when executed by at least one processor, the computer-executable instructions cause the processor to:
receive a specified scope of work from the computer device located at a site of a performance of the work;
generate, on the computer device, a draft proposal for performing the scope of work at the site of the performance of the work;
transmit an approval request, including the draft proposal, to a site remote from the site of the performance of the work;
receive, from the remote site, at least one of an approval the draft proposal of the scope of work and denial of the draft proposal of the scope of work;
transmit the approved proposal to a client associated with the identified location of the specified scope of work; and
receive from the client an approval to perform the specified scope of work.

10. The computer-readable storage media of claim 9, wherein the computer-executable instructions further cause the processor to:
receive an identification of a geographic location of the proposed scope of work;
acquire a photo of a proposed scope of work;
display, on the computer device, a plurality of graphic icons depicting predetermined tasks relating to the scope of work; and
receive, on the computer device, a selection of one or more of the plurality of graphic icons that graphically describe the proposed scope of work; and
convert the received selection of graphic icons into textual descriptions of the scope of work in the draft proposal.

11. The computer-readable storage media of claim 9, wherein the computer-executable instructions further cause the processor to:
display, on the computer device, a graphical map having selectable locations, the selectable location selectable by outlining an area of the selectable location on the displayed graphical map;
receive a selection on the displayed map that corresponds to the location of the proposed scope of work;
generate location coordinates of the selected location; and
store the location coordinates in a database storage location associated with the client.

12. A computer-implemented method for managing services, the method implemented using a computer device coupled to a user interface and a memory device, the method comprising:
receiving a specified scope of work from the computer device located at a site of a performance of the work;
generating, on the computer device, a draft proposal for performing the scope of work at the site of the performance of the work;
transmitting an approval request, including the draft proposal, to a site remote from the site of the performance of the work;
receiving, from the remote site, at least one of an approval the draft proposal of the scope of work and denial of the draft proposal of the scope of work;
transmitting the approved proposal to a client associated with the identified location of the specified scope of work; and
receiving from the client an approval to perform the specified scope of work.

13. The method of claim 12, wherein specifying a scope of work comprises:
identifying a geographic location of the proposed scope of work;
acquiring a photo of a proposed scope of work;
displaying, on the computer device, a plurality of graphic icons depicting predetermined tasks relating to the scope of work; and
receiving, on the computer device, a selection of one or more of the plurality of graphic icons that graphically describe the proposed scope of work; and
converting the received selection of graphic icons into textual descriptions of the scope of work in the draft proposal.

14. The method of claim 13, wherein identifying a location of the proposed scope of work comprises:
displaying, on the computer device, a graphical map having selectable locations, the selectable location selectable by outlining an area of the selectable location on the displayed graphical map;
receiving a selection on the displayed map that corresponds to the location of the proposed scope of work;
generating location coordinates of the selected location; and
storing the location coordinates in a database storage location associated with the client.

15. The method of claim 14, wherein generating location coordinates of the selected location comprises generating at least one of an address of the selected location, a geo-location of the selected location, and an assignment as a sublocation of a previously identified location.

16. The method of claim 13, wherein displaying a plurality of graphic items of predetermined tasks relating to the scope of work comprises displaying a plurality of at least one of language independent graphic items and internationally recognized graphic items.

17. The method of claim 13, wherein receiving a selection of one or more of the plurality of graphic items comprises associating each selection with at least one of a category of the scope of work related to the selection, a textual description of the scope of work, and a price for completing the scope of work.

18. The method of claim 12, wherein approving a proposal of the scope of work comprises:
generating a proposal for the proposed scope of work including the selected predetermined tasks;
transmitting the generated proposal to a predetermined routing list of approving recipients; and
receiving an approval for the transmitted proposal.

19. The method of claim 12, further comprising documenting actual work performed at the site of the performance of the work.

20. The method of claim 19, wherein documenting actual work performed comprises assigning, via the computer device, man-hours expended for each task.
